(19) United States
(12) Patent Application Publication
(10) Pub. No.: US 2007/0156311 A1
(43) Pub. Date: Jul. 5, 2007

(54) Communication of automotive diagnostic data

(76) Inventors: Albert Fitzgerald Elcock, Havertown, PA (US); Thomas F. Kister, Chalfont, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/321,562

(22) Filed: Dec. 29, 2005

(51) Int. Cl. G06F 19/00

(52) U.S. Cl. 701/29; 340/438

(57) ABSTRACT

Wireless communication is established between a vehicle having one or more on-board diagnostic systems and a mobile phone. Automotive diagnostic data is received by the mobile phone to indicate, for example, that maintenance is required for the vehicle or the occurrence of an event such as an airbag deployment or security breach. Automotive diagnostic data is uploaded from the mobile phone to a service center to generate service call reminders, welfare checks or to track vehicle performance, system usage or component wear.

### BACKGROUND

Automobiles reflect one of the largest single expenses for many households, second often only to housing costs. Regular maintenance can prolong the useful life of a car as well as enhance its safety and reliability. Unfortunately, it is all too easy for many car owners to overlook routine and preventative maintenance which can have an adverse impact on fuel economy, exhaust emissions and performance. While today's cars can continue to function for a long time, even the most robust and maintenance-free models will eventually succumb to lack of maintenance and break down.

Due to legal requirements enacted to reduce the emissions of motor vehicles, the United States since 1996 and the European Union beginning in 2000 have required new cars to be equipped with on-board diagnostic (“OBD”) systems. These OBD systems—either as a component of the one or more on-board electronic control unit (“ECU”) that are typically used with the vehicle's major subsystems (such as the engine management system, safety systems, transmission controller, climate control etc.) or in combination therewith—detect fundamental operating parameters of the vehicle, as well as its emissions values, using appropriate sensors.

Malfunctions of the vehicle are determined by comparing these operating parameters with predetermined recommended variables. The occurrence of a malfunction is indicated in the vehicle using a multi-function indicator lamp (“MIL”) which is commonly called the “check engine light.” However, the specific information needed for identifying and repairing these malfunctions is available via a diagnostic interface called an OBD port. The OBD port is located in the vehicle's interior compartment and typically outputs diagnostic “codes” to enable external diagnostic equipment to communicate with the vehicle's subsystems and sensors and monitor the fundamental operating parameters.

While OBD systems are very sophisticated and can often provide valuable early warning of an impending problem, the MIL is a source of frustration for many vehicle operators. Generally, the special diagnostic tools needed to read the trouble codes generated by the OBD systems and turn the MIL off are not commonly possessed except by professional service technicians. And, having only the MIL itself as an indicator provides limited information to the vehicle's operator. It can be triggered from anything from a routine but relatively minor problem such as a dirty air filter to problems that if left unchecked could lead to expensive repairs or dangerous failures in the vehicle.

The diagnostic data generated by automotive OBD systems needs to be connected to diagnostic equipment, as described above, or otherwise supplied to a service provider for the benefits of such OBD systems to be fully realized. Telematic systems have been recently developed to address this need, at least in part. Such systems are generally considered a cross between a communications system and computer system and consist of an on-board computer, a wireless connection to a wireless data network and a global positioning system (“GPS”) that are installed and operated in the vehicle.

A telematic system can notify an entity that is monitoring the system (such as a service provider, for example) when the MIL or a safety system is activated. When a safety system is activated such as the deployment of an airbag, an operator typically calls the car over the telematic system to make sure the passengers are okay—and if they are not, then the operator sends help. GPS data tells the operator where to send the police and ambulance or other emergency responders. While several major automobile manufacturers are beginning to equip their new vehicles with telematic systems, these systems can be costly, are not available in all models, and are not able to be readily retrofitted to older vehicles.

### BRIEF DESCRIPTION OF THE DRAWINGS

FIG. 1 is a simplified pictorial representation of an illustrative cockpit area of a vehicle which shows a expanded view of an OBD DLC (diagnostic link connector) that is typically located in or around the dashboard of the vehicle;

FIG. 2 is a diagram showing connector and conductor details of an OBD “Type A” DLC that is used to connect to an on-board diagnostic system of a vehicle;

FIG. 3 is a diagram showing connector and conductor details of an OBD “Type B” DLC that is used to connect to an on-board diagnostic system of a vehicle;

FIG. 4 is a is a functional block diagram of an illustrative communications module that is arranged to connect to a vehicle's OBD DLC;

FIG. 5 is pictorial view of the illustrative communications module shown in FIG. 4;

FIG. 6 is a pictorial view of the communications module shown in FIG. 4 in an operative relationship with a vehicle's OBD DLC prior to being mateably engaged and after being mateably engaged;

FIG. 7 is a diagram of an architecture for an illustrative vehicle application for a mobile phone for interacting with vehicle diagnostic data;

FIG. 8 is a pictorial representation of a main application menu for display on a mobile phone;

FIG. 9 is a pictorial representation of an illustrative graphical user interface display for a mobile phone which shows a main menu for a vehicle application;

FIGS. 10 and 11 are pictorial representations of illustrative graphical user interface displays for a mobile phone which show security alerts;

FIGS. 12, 13, and 14 are pictorial representations of graphical user interface displays for a mobile phone to facilitate use of the mobile phone as an automotive diagnostic tool;

FIG. 15 is a pictorial representation of an illustrative graphical user interface display for a mobile phone to facilitate the display of maintenance alerts and notifications;

FIG. 16 is a pictorial representation of an illustrative graphical user interface display for a mobile phone showing an incoming call from a call center operator;

FIG. 17 is a pictorial representation of an illustrative graphical user interface display for a mobile phone to facilitate remote interaction with a vehicle;

FIG. 18 is a diagram of an illustrative arrangement where a mobile phone uploads vehicle diagnostic data over one or more networks;

FIG. 19 is a flowchart of an illustrative method for monitoring and uploading vehicle diagnostic data to a service center; and,

FIG. 20 is a is a pictorial representation of an illustrative graphical user interface menu for a mobile phone arranged to provide user-selectable controls for uploading vehicle diagnostic data to a service center.

### DETAILED DESCRIPTION

An effective way to monitor and communicate automotive diagnostic data is accomplished through an arrangement where wireless communication is established between a vehicle having one or more on-board diagnostic systems and a mobile phone. In various illustrative arrangements, automotive diagnostic data is received by the mobile phone to indicate, for example, that maintenance is required for the vehicle or the occurrence of an event such as an airbag deployment or security breach. The mobile phone is enabled with automotive diagnostic scanning and testing capabilities. Automotive diagnostic data is uploaded from the phone to a call center or service provider to generate service call reminders, welfare checks or to track vehicle performance, system usage or component wear. The mobile phone advantageously provides a convenient and familiar user interface to the vehicle's on board diagnostic systems. In addition, the combination of mobile phone and communications module enables telematic-like capabilities to be added to older vehicles or new vehicles that are not factory equipped with such features.

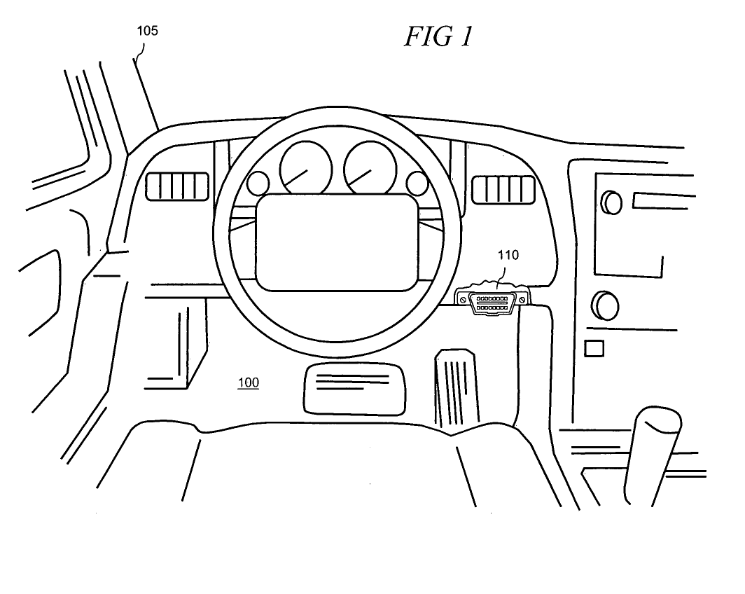

FIG. 1 is a simplified pictorial representation of an illustrative cockpit area 100 of a vehicle 105 which shows an expanded view of an OBD diagnostic link connector (“DLC”) 110 that is typically located in or around the dashboard. OBD DLC 110 is coupled to one or more on-board diagnostic systems in the vehicle 105. In most applications, OBD DLC 110 is compliant with either OBD Generation I (“OBD-I”) or OBD Generation II (“OBD-II”) specifications as defined by the Society of Automotive Engineers (“SAE”) and the International Organization for Standardization (“ISO”).

In the illustrative example shown in FIG. 1, OBD DLC 110 is an OBD-II plug in conformance with SAE J1962. This specification states that a DLC should be located in the passenger or driver's compartment and attached to the instrument panel while being easy to access from the driver's seat. It further specifies that the preferred location of a DLC is between the steering column and centerline of the vehicle. The location of OBD DLC 110 meets the preferred locations stated in SAE J1962 as shown in FIG. 1.

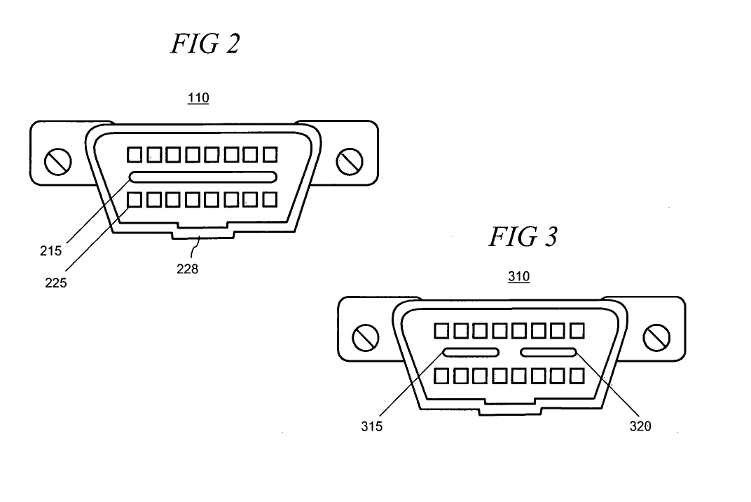

SAE J1962 further defines two types of DLCs (“Type A” and “Type B”) that differ primarily in the shape of an alignment slot disposed therein. FIG. 2 is a diagram of OBD DLC 110 showing details of the alignment slot 215 and conductors 225. OBD DLC 110 uses a single centrally disposed alignment slot 215 which is in conformance with the SAE J1962 Type A DLC specifications. As shown in FIG. 2, the conductors 225 are arranged in two rows about the alignment slot 215. The conductors are recessed into the body 228 of OBD DLC 110 to mateably engage with a compatible connector having projecting conductors in a “female” to “male” configuration. FIG. 3 shows a Type B OBD DLC 310 that uses two alignment slots 315 and 320.

A number of different communication protocols are used with OBD systems and require different pin arrangements in DLCs. Common communication protocols that are useable with the present arrangement include, but are not limited to SAE J1850 PWM, SAE J1850 VPW, ISO 9141-2, ISO 14230-4 and ISO 15765-4/SAE J2480. Many devices today such as external diagnostic equipment used at repair shops are designed for connection to an OBD port in a vehicle so that, upon being plugged in, the equipment determines the protocol used by the ODB port, and properly addresses the pin array to then receive and interpret the data received from the OBD port.

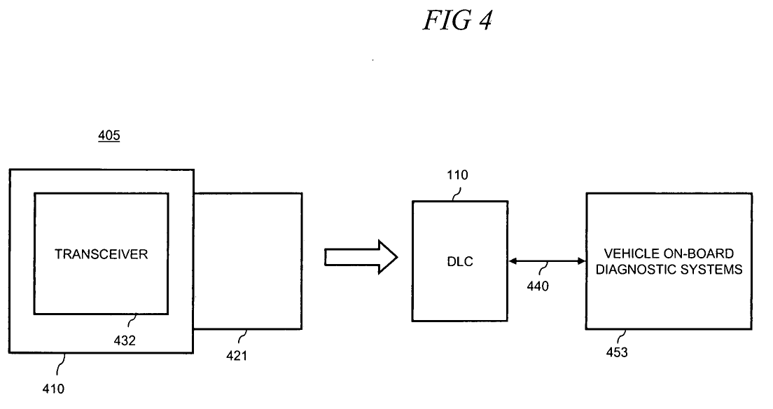

FIG. 4 is a simplified functional block diagram of the illustrative communications module 405 that is arranged to connect to a vehicle's OBD DLC such as OBD DLC 110 (FIG. 1). Communications module includes a housing 410 in which is disposed a transceiver 432. Coupled to, and supported by the housing 410 is a connector 421 that is arranged to be operatively removably connectable with ODB DLC 110. OBD DLC 110 is connected over vehicle wiring 440 to one or more vehicle on-board diagnostic systems 452.

The housing 410 and connector 421 are configured to be relatively compact in size so that the communications module 405 is capable of being connected to the OBD DLC 110 with minimal intrusion into the surrounding passenger compartment.

Transceiver 432 is arranged to send and receive signals with a mobile phone (not shown) using one of a variety of conventional wireless communications protocols. Such protocols include, for example, Bluetooth, ZigBee, Institute of Electrical and Electronic Engineers (IEEE) 802.11, Wi-Fi, wireless USB (universal serial bus), ultra wideband wireless (“UWB”), magnetic and infrared (“IR”) links

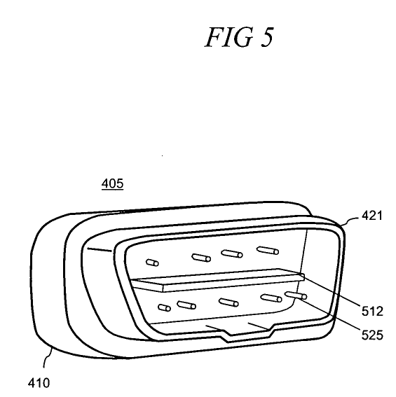

FIG. 5 is a pictorial representation of communications module 405 (FIG. 4). A centrally located alignment tab in the connector 421 is arranged to be removably engageable with the alignment slot 215 in OBD DLC 110 (FIG. 1). Protruding conducting pins 525 are arranged to be removably insertable into the recessed conductors 225 (FIG. 2) in OBD DLC 110.

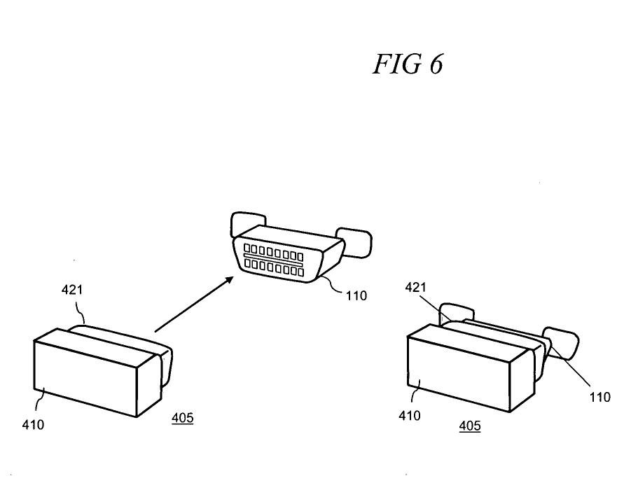

FIG. 6 is a pictorial view of the communications module 405 (FIG. 4) in an operative relationship with a vehicle's OBD DLC 110 (FIG. 1) prior to being mateably engaged and after being mateably engaged. Upon mateable engagement, the communications module is operatively coupled to one or more on-board diagnostic systems in the vehicle 105 (FIG. 1) via the OBD DLC 110.

In some applications, the communication module 405 is arranged to draw operating or recharging power through the OBD DLC 110 from the vehicle's electrical system (i.e., battery and charging system). Accordingly, communications module 405 is able to be left coupled to OBD DLC 110 on an indefinite basis to provide continuous monitoring of the vehicle's on-board diagnostic system using the present arrangement. A battery (not shown) is optionally included in the communications module 405 to supplement vehicle-supplied power if required.

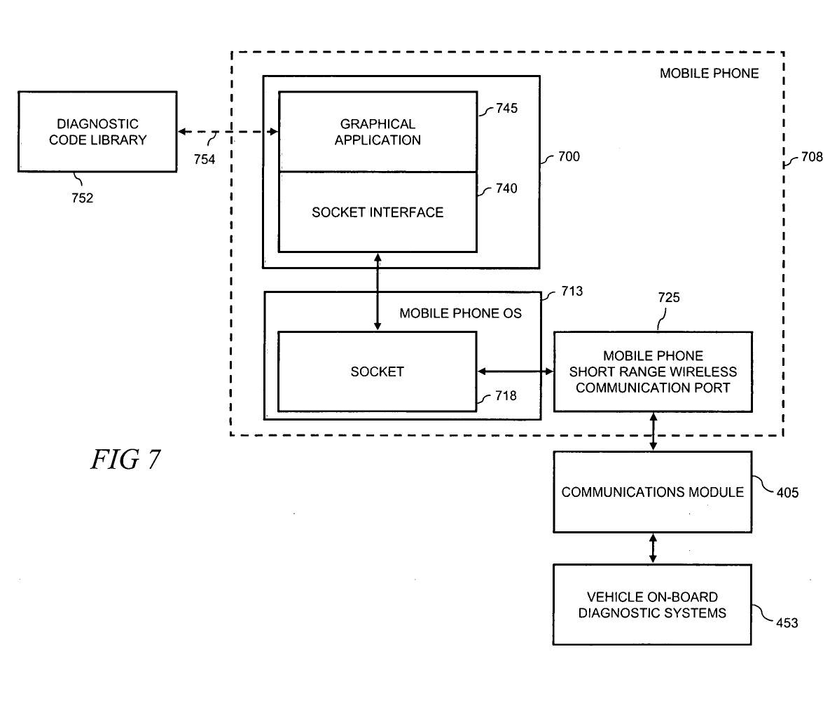

FIG. 7 is a diagram of an illustrative architecture for a vehicle application 700 arranged to run on a mobile phone 708 to enable interaction with diagnostic data from a vehicle. The term “mobile phone” generally refers to portable telephone devices using wireless radio wave transmission technology to access a large scale communications network. Mobile phones that are usable in the present arrangement include, for example, cell phones, satellite phones, smart phones, personal digital assistants (PDAs), pocket PCs (personal computers) and the like. Other electronic devices may also be used in alternative arrangements including devices such as music players that use the ISO MPEG Audio Layer III (International Standards Organization Moving Pictures Expert Group) standard known as MP3.

Vehicle application 700 runs on top of a mobile phone OS 713 (operating system) which takes care of basic mobile phone functions and hardware as well as dealing with software file management, among other functions. OS 713 includes a socket 718 that enables a bi-directional communications link with a port 725 disposed in the mobile phone 708. Port 725, in this illustrative example, is configured as a short-range wireless communication port using Bluetooth. Accordingly socket 718 is correspondingly configured as a Bluetooth socket. Such short-range communication networks are commonly called wireless personal area networks and are commonly enabled with measures designed to enhance network security and privacy.

Port 725 is coupled to receive Bluetooth compatible communications from communications module 405 (FIG. 4). Communications module 405 thus functions to relay data from the vehicle on-board diagnostic systems 453 to the mobile phone 708. In addition, communications module 405 relays signals (including control and command signals as discussed below) from the mobile phone 708 to the vehicle on-board diagnostic systems 453.

In the vehicle application 700, a socket interface layer 740 communicates with the OS socket 718 below it and a graphical application 745 above it to enable communication of data and commands between the graphical application 745 and the communications port 725. Thus, vehicle application 700 is utilized to facilitate viewing of the vehicle diagnostic data coming from the vehicle's on-board diagnostic systems as well as supporting user interaction with those systems.

The graphical application 745 provides a user interface for the vehicle application 700. Such a graphical application is required as most mobile phone operating systems do not provide an end-user interface. Thus, dialogs, toolbars, menu bars and menu panes needed for the vehicle application 700 are all provided by graphical application 745. Graphical application 745 is optionally linked to an external resource, for example, a diagnostic code library 752, as indicated by the dashed line 754 in FIG. 7.

Vehicle application 700 is arranged to run as one of several user-selectable applications that are available on the mobile phone 708. FIG. 8 is a pictorial representation of a main application menu 800 displayed on the display screen of mobile phone 708 (FIG. 7) showing a vehicle application named “My Car” as indicated by reference numeral 810. A variety of other applications 820 are displayed and available for selection by the mobile phone user, as well as several icons 830 that are representative of those typically provided on a mobile phone display including a signal strength indicator and battery level indicator.

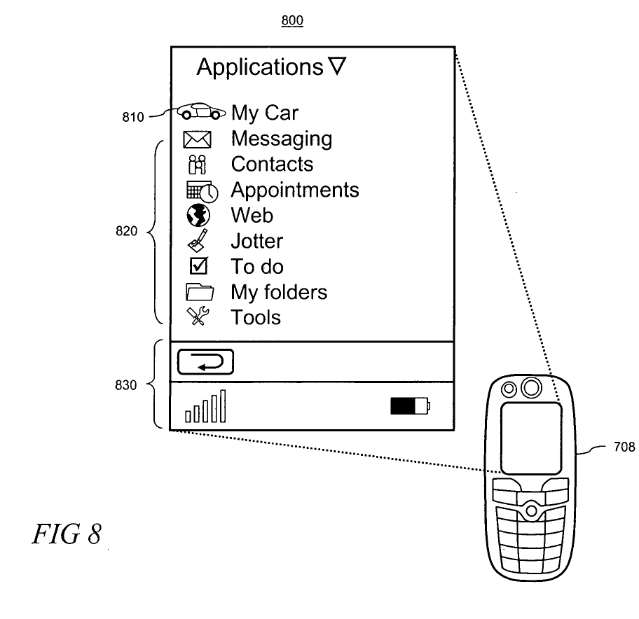

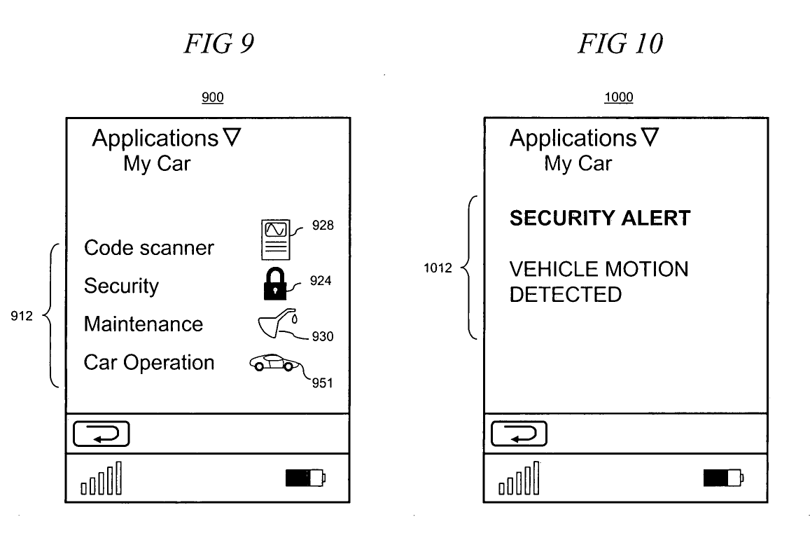

FIG. 9 is a pictorial representation of an illustrative graphical user interface (“GUI”) display 900 for mobile phone 708 (FIG. 7) which shows a main application menu for vehicle application 700 (FIG. 7). FIG. 9 is an example of a GUI that is rendered by graphical application 745 (FIG. 7) for vehicle application 700. The vehicle application 700 includes four user-selectable components: a code scanner feature, a security feature, a maintenance feature, and a car operation feature as shown by text and icons in the GUI display as indicated by reference numeral 912 in FIG. 9.

FIG. 10 is a pictorial representation of an illustrative graphical user interface display 1000 for a mobile phone which shows a security alert 1012 on the screen. The security alert, in this illustrative example is generated when the mobile phone 708 (FIG. 7) receives vehicle diagnostic data generated by a vehicle motion sensor in vehicle 105 (FIG. 1). As noted above, the vehicle diagnostic data is received by the communications module 405 (FIG. 4) through the OBD DLC 110 (FIG. 1) which is relayed by transceiver 432 (FIG. 4) to mobile phone 708. Optionally, an audible alert, such as a special ring tone is played on the mobile phone to accompany the graphical alert shown in FIG. 10.

Advantageously, such security feature can alert a vehicle's owner of a theft attempt or other unauthorized use of the vehicle. Many users routinely carry their mobile phones in a pocket, a pocketbook, or clipped to a belt, so the present arrangement provides a convenient means to effectuate an alert that is highly likely to be received by the intended recipient.

Users are directed to a menu to set up preferences regarding the security feature by selecting security icon 924 in FIG. 9. For example, a user may select from more than one vehicle security sensor if the vehicle is so equipped. Security sensor activation thresholds are also selectable in some applications. Such settings and selections are made using vehicle application 700 (FIG. 7) on the mobile phone 708 which are then transmitted to communications module 405 which, in turn, relays them to the appropriate controller in the on-board diagnostic system for handling.

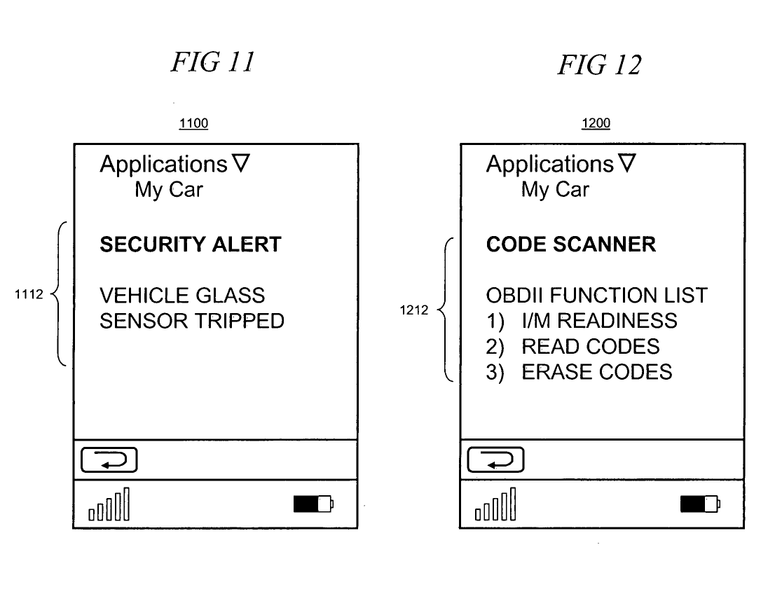

FIG. 11 shows a security alert 1112 from a glass sensor in the vehicle which is configured to detect glass breakage. Other security sensors that are often included in vehicles and tied into on-board diagnostic systems include those used to detect: vehicle tilt, door opening, truck opening, ignition switched on, battery voltage drop and interior air pressure changes. Proximity sensors which detect the presence of a person or object coming near or in contact with the vehicle are also usable with present arrangement.

Users are directed to a menu to enable the mobile phone 708 (FIG. 7) to function as a code scanner by selecting the code scanner icon 928 in FIG. 9. Code scanners (which are also called code readers) are typically used in automotive repair facilities to interface with on-board diagnostic systems in vehicles to, for example, access and display diagnostic trouble codes. Some code scanners are also configured to interact with the on-board diagnostic systems and components therein to perform testing which often entails viewing and displaying real-time, dynamic data from a plurality of sensors. Code scanners may also be configured to allow manual control of vehicle sensors and control modules in the vehicle for diagnosis or repair purposes.

FIG. 12 shows an illustrative GUI display of a main menu 1200 for the code scanner feature. Menu 1200 includes a display of typical user-selectable code scanner functions as indicated by reference numeral 1212. These include reading I/M (inspection and maintenance) readiness status of the plurality of on-board sensors in the vehicle, reading diagnostic trouble codes, and erasing the diagnostic trouble codes from the vehicle's on-board diagnostic system (which allows the user to reset the MIL and distinguish the check engine light).

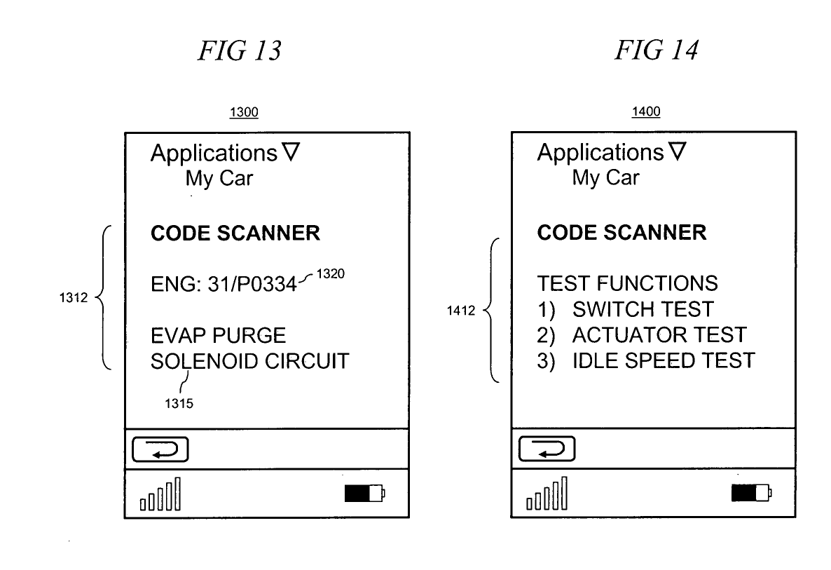

FIG. 13 shows an illustrative GUI display 1300 showing a typical diagnostic trouble code 1312 that is read from a vehicle's on-board diagnostic system. GUI display 1300 is accessible from the icon 928 on the main application menu 900 (FIG. 9). A textual description 1315 of the code 1320 is also shown. The textual description 1315 is an example of data used to supplement the diagnostic data obtained from the vehicle in some applications. Such data is typically obtained from a source that is external to the vehicle application 700 such as a linked external library 752 as shown in FIG. 7 and described in the accompanying text.

FIG. 14 shows an illustrative GUI display 1400 showing several illustrative tests 1412 that are user-selectable on mobile phone 708 (FIG. 7) when operating as a code scanner. Such tests may involve the interaction with various sensors and controllers in the vehicle. Control and command signals from a user responsively to GUI display 1400 are captured by the vehicle application 700 (FIG. 7) and relayed using the communications module 405 (FIG. 4) to the appropriate sensors and controllers in the vehicle as are required to perform the tests.

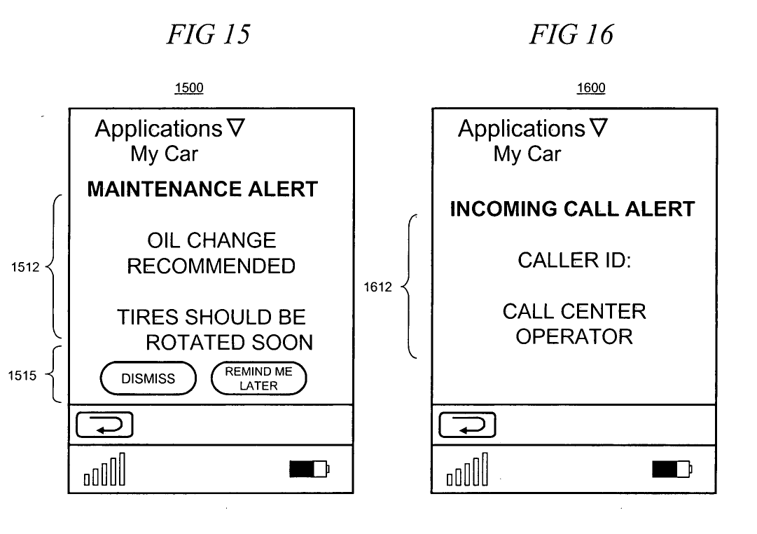

FIG. 15 shows an illustrative GUI display 1500 that facilitates the use of mobile phone 708 (FIG. 7) to display one or more maintenance alerts and notifications. A maintenance alert 1512 includes illustrative two messages as shown. In most applications, maintenance alerts are generated by a service center responsively to vehicle diagnostic data as described in more detail below. Alternatively, the vehicle's on-board diagnostic systems generate the alerts which are receivable as vehicle diagnostic data over the OBD DLC 110 (FIG. 1) by communications module 405 (FIG. 4). Maintenance alerts are provided as a convenient reminder for users that services such as routine oil changes and tire rotations are due. Accordingly, most such alerts are “pushed” into the mobile phone 708 without action from the user. As shown in FIG. 15, buttons 1515 are provide for a user to select a disposition for the alerts.

Users are directed to a menu to set up preferences regarding the maintenance alert feature by selecting icon 930 in FIG. 9. For example, the feature can be turned on and off, and the time interval before a reminder is sent again is user-settable.

FIG. 16 shows an illustrative GUI display 1600 that facilitates the use of mobile phone 708 (FIG. 7) to display an alert of an incoming call from an operator at a remote call center or service center. Such calls are placed, for example, when vehicle diagnostic data indicates that an event has occurred such as an activation of a safety system (e.g., an airbag deployment that prompts a welfare check of the vehicle's occupants), or a sensor in the on-board diagnostic system indicates a critical malfunction in the vehicle needs immediate attention, and the like.

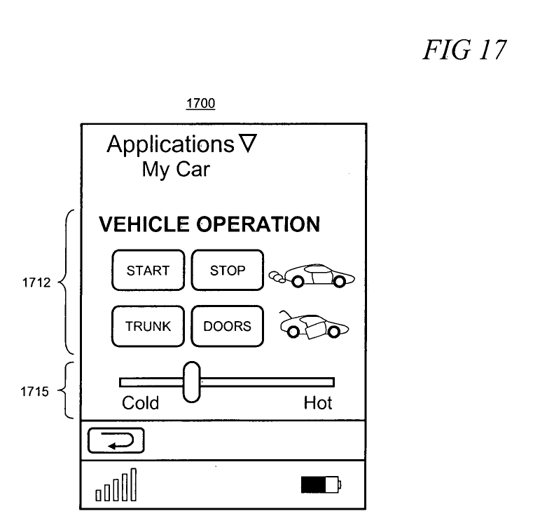

FIG. 17 shows an illustrative GUI display of a main menu 1700 provided to facilitate the use of mobile phone 708 (FIG. 7) to operate systems and subsytems in vehicle 105 (FIG. 1) remotely. GUI display 1700 is accessible by selecting icon 951 on main application menu 800 (FIG. 8). Menu 1700 includes a display of user-selectable controls 1712 to operate the vehicle using the mobile phone 708 from a distance. Such controls include remote starting, truck and door lock releases and a climate control system operation (using a graphical slider object 1715) as shown. Control and command signals from a user responsively to menu 1700 are captured by the vehicle application 700 and relayed using the communications module 405 (FIG. 4) to the appropriate sensors and controllers in the vehicle as are required to perform selected remote operations.

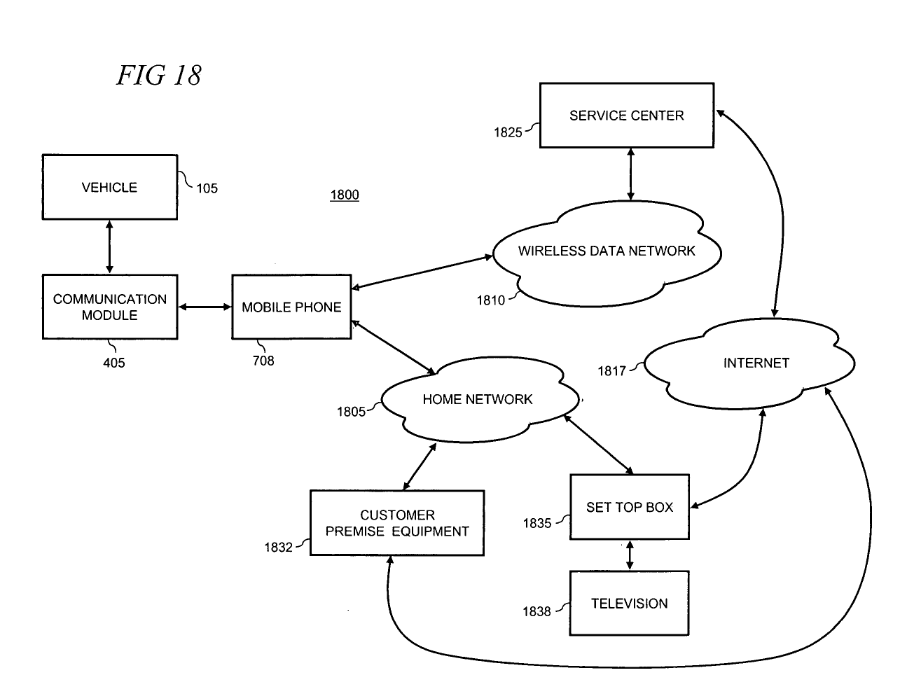

FIG. 18 is a diagram of an illustrative arrangement 1800 where a mobile phone 708 (FIG. 1) uploads vehicle diagnostic data over one or more networks, including a home network 1805, wireless data network 1810, and Internet 1817. Mobile phone 708 is operatively connected to communications module 405 (FIG. 4) which is, in turn, coupled to vehicle 105 (FIG. 1) and its on-board diagnostic systems as described above in the text accompanying FIG. 7. In this illustrative arrangement, mobile phone 708 communicates with the home network 1805 using either wired (e.g., USB—universal serial bus) or wireless links (e.g., infrared, Wi-Fi, Bluetooth, etc.)

Home network 1805 is selected from one of a variety of conventional networks including wireless and wired local area networks such as an Ethernet network, powerline network, phone line network or wireless network (e.g., Wi-Fi, or Bluetooth).

Wireless data network 1810 is selected from one of a variety of conventional networks that are typically accessed by mobile phone 708 including GPRS, WAP, UMTS, EV-DO, 2G, 2.5G, 3G, 4G, IDEN, TDMA, CDMA, PDC, 2G CDMA, WiFi, WiMAX, W-CDMA, GSM, EDGE, TD-SCDMA and CDMA2000.

Each of the networks shown in FIG. 18 is connected either directly or indirectly to a service center 1825. Service center 1825 is typically operated by a service provider who operates a call center or other facility that can receive vehicle diagnostic data from the mobile phone 708 and provide responsive services such as maintenance alerts and welfare calls as described above in the text accompanying FIGS. 15 and 16.

Home network 1805 is coupled to customer premise equipment 1832 and set top box 1835 (which is, in turn, coupled to a television 1838). Both customer premise equipment 1832 and set top box 1835 are commonly configured to provide residential users with high-speed data and/or video services and can provide access to the Internet network 1817 as shown.

The arrangement shown in FIG. 18 is used, in an illustrative example, to communicate vehicle diagnostic data received by the mobile phone 708 (FIG. 7)—from an on-board diagnostic system in vehicle 105 (FIG. 1) via communications module 405 (FIG. 4)—to the service center 1825. Accordingly, mobile phone 708 stores a selected subset of received vehicle diagnostic data in a memory that is disposed in the mobile phone. The stored vehicle diagnostic data is uploaded to the service center 1825 during the next communications session in which the mobile phone is operatively connected to one of the networks 1805, 1810, or 1817.

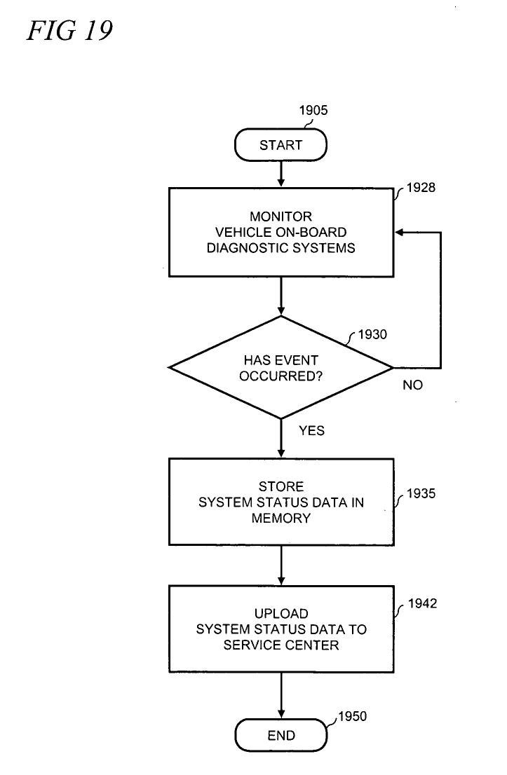

Such uploading method is shown in the illustrative flowchart in FIG. 19. The method starts at block 1905. At block 1928, diagnostic data from an on-board diagnostic system in vehicle 105 (FIG. 1) is monitored by mobile phone 708 (FIG. 7). If an event occurs at decision block 1930, then the data associated with such an event is stored in a memory of mobile phone 708. If no event occurs, then control is passed back to block 1928 and monitoring continues.

An event includes a change in status or other signal from the vehicle's on-board diagnostic system that typically warrants additional analysis at the service center. For example, if an engine operating parameter drops below a defined threshold, which might indicate a developing problem, then a number of datapoints which define an operating parameter history are collected from one or more vehicle sensors disposed in the on-board diagnostic system and stored in the mobile phone memory as shown in block 1935.

At block 1942, the stored vehicle diagnostic data is uploaded to the service center, for example over the networks and devices shown in FIG. 18. The method ends at block 1950.

In an illustrative example, a user has mobile phone 708 in a jacket pocket while setting off on a trip in vehicle 105. The mobile phone 708 is in operative communication with communications module 405 (FIG. 4) that the user coupled via the OBD DLC 110 (FIG. 1) to the vehicles on-board diagnostic system prior to the start of the trip. During the drive, engine oil pressure drops below a defined threshold which is sensed by a sensor coupled to the engine's ECU. As engine oil pressure is a critical operating parameter, an event is triggered so that mobile phone 708 begins to log operating parameters associated with the engine and its related systems including, for example, engine temperature, coolant temperature, oil pressure, oil temperature, engine speed, engine load and other engine operating parameters under a variety of driving conditions over time. This data is stored in the memory of mobile phone 708. In other illustrative examples, similar monitoring may be performed for other critical operating parameters, or on vehicle components that are subject to wear such as brake and clutch linings.

After the trip concludes back at the user's residence, the mobile phone is placed into operative communication with one of the network shown in FIG. 18 to thereby upload the vehicle diagnostic data stored in the mobile phone's memory to the service center 1825 (FIG. 18). The service center analyzes the uploaded vehicle diagnostic data and takes appropriate action such as sending an alert or placing a call to the mobile phone 708 as described in the text accompanying FIGS. 15 and 16. Continuing with the engine oil pressure example above, if analysis of the uploaded data indicates that the level of the engine oil in the vehicle is low or the engine oil is beyond its service limit, then a maintenance alert is sent by the service center to the mobile phone 708 to indicate that the engine oil level should be topped up, or changed, respectively.

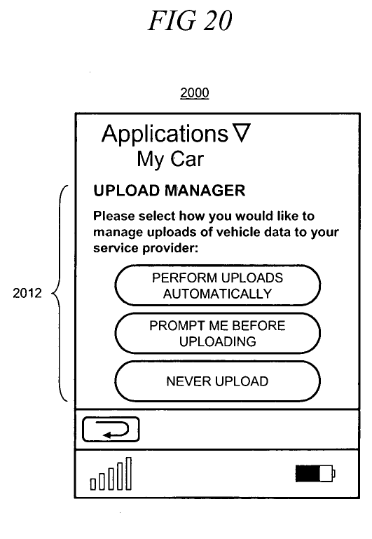

FIG. 20 is a is a pictorial representation of an illustrative graphical user interface menu 2000 for a mobile phone arranged to provide user-selectable controls for uploading vehicle diagnostic data to a service center. As shown, the user is presented with a number of user-selectable options 2012 to set preferences for uploading stored vehicle diagnostic data from mobile phone 708 (FIG. 7) to a service center, service provider or other device or network as required by the needs of a specific application.

1. A communications module, comprising:
a housing;
a module connector supported by the housing for connecting to a diagnostic jack of a vehicle's on-board diagnostic system; and
a transceiver arranged to communicate with a mobile telecommunications device having wireless data network access.

2. The communications module of claim 1 in which the mobile telecommunications device is selected from one of mobile phone, pocket PC, PDA, MP3 player and pager.

3. The communications module of claim 1 in which the transceiver communicates with the mobile telecommunications device using a wireless communication link selected from one of RF, Bluetooth, 802.11, UWB, magnetic and IR links.

4. The communications module of claim 1 in which the transceiver is operative with a plurality of different vehicle bus protocols.

5. The communications module of claim 4 in which the different vehicle bus protocols adhere to one of SAE J1850 PWM, SAE J1850 VPW, ISO 9141-2, ISO 14230-4 and ISO 15765-4/SAE J2480.

6. The communications module of claim 1 where the jack is an OBD-I or OBD-II compatible DLC.

7. The communications module of claim 1 that is further arranged to receive operating power from the jack.

8. The communications module of claim 1 in which the transceiver is operative for transmitting vehicle diagnostic codes.

9. The communications module of claim 1 where the on-board diagnostic system is an on-board diagnostic system generation II (OBD-II) system.

10. A method of providing a service for enabling interaction between a mobile phone and a vehicle with an on-board diagnostic system, comprising:
monitoring the on-board diagnostic system for vehicle diagnostic data;
determining from the vehicle diagnostic data when a vehicle event occurs;
storing at a subset of the vehicle diagnostic data in a memory disposed in the mobile phone; and
uploading the at least a subset of vehicle diagnostic data from the memory responsively to the determination of the vehicle event.

11. The method of claim 10 in which the vehicle event is selected from one or more of the group consisting of vehicle motion, vehicle tilt, door opening, truck opening, ignition switched on, battery voltage drop, interior air pressure change, proximity sensor activation, and glass breakage.

12. The method of claim 10 in which the vehicle event is associated with maintenance of one or more subsystems contained in the vehicle.

13. The method of claim 12 in which the one or more subsystems is one of engine, transmission, powertrain, brakes, emission control, stability control, traction control, climate control, navigation subsystem, entertainment subsystem, airbag subsystem, fuel subsystem, anti-theft subsystem and vehicle lighting subsystem.

14. The method of claim 10 further including sending a service reminder to the mobile phone from a service center responsively to the uploaded vehicle diagnostic data.

15. The method of claim 10 in which the uploaded vehicle diagnostic data indicates that maintenance is required for the vehicle.

16. The method of claim 10 further including sending a welfare check call from a service center to the mobile phone responsively to the uploaded vehicle diagnostic data.

17. A software application for a mobile phone, comprising:
a graphical application arranged to run on the mobile phone's OS, the graphical application providing a user interface for viewing automotive diagnostic data; and
a socket interface for communication with an OS socket arranged to receive automotive diagnostic data over a port disposed in the mobile phone.

18. The software application of claim 17 in which the graphical application is further arranged to display automotive diagnostic codes and textual diagnostic description on a display screen disposed in the mobile phone.

19. The software application of claim 17 in which the graphical application is further arranged to display a vehicle service notice.

20. The software application of claim 17 further including an upload manager for uploading the received automotive diagnostic data to a device that is operatively connectable to the mobile phone.

21. The software application of claim 20 in which the device is selected from one of set top box, smart appliance, customer premise equipment and computer server.
